(19) United States
(12) Patent Application Publication
(10) Pub. No.: US 2025/0253604 A1
(43) Pub. Date: Aug. 7, 2025

(54) JUMPER TOOL FOR A CABLE TV NETWORK DISTRIBUTION TAP

(71) Applicant: TECHNETIX B.V., Veenendaal (NL)

(72) Inventors: Gareth SHELLEY, Veenendaal (NL); Paul CHAPMAN, Veenendaal (NL)

(21) Appl. No.: 18/934,163

(22) Filed: Oct. 31, 2024

(30) Foreign Application Priority Data
Feb. 6, 2024 (GB) 2401552.1

(51) Int. Cl. H01R 31/08

(52) U.S. Cl. CPC H01R 31/08; H01R 2201/18

(57) ABSTRACT

There is provided a jumper tool (60) configured for use with a CATV back box (10) comprising a substantially horizontal U-shaped housing (62) bent at each open end of the U-shape to form first and second downwardly depending limbs (66, 66′) and further comprising an electrically conductive elongate element (70) located within the housing (62) and passing from the first downwardly depending limb (66) to the second downwardly depending limb (66′) so as to provide an electrical connection passing between each limb.

### FIELD OF THE INVENTION

This invention relates to a jumper tool for a back box component of a broadband distribution tap used in cable TV (CATV) networks.

### BACKGROUND TO THE INVENTION

Distribution taps are used in CATV networks to connect broadband services to subscriber homes. A CATV distribution tap consists of a permanently connected back box and a removable faceplate on which is mounted a coupler circuit that divides the signal between the output and an internal splitter circuit, which subsequently divides the remaining signal equally between 2, 4 or 8-way tap outputs that connect to subscriber premises via coaxial cables. The faceplate and back box connect electrically via two internal connectors.

In a CATV network, the taps are cascaded together with the output of one tap connected to the input of the next in the chain. To extend the reach of the network amplifiers are positioned throughout the chain to boost the broadband signal. As technology has advanced, the frequency band over which CATV signals are transmitted has increased, which has required the upgrading of the tap faceplates. The faceplate circuits and components have become more complex and in some cases the faceplates have increased in depth to accommodate larger components.

Each tap back box contains a mechanical switched bypass circuit that connects the output to the input when the faceplate is removed for maintenance or upgrade, thus maintaining power and signal to all downstream taps and amplifiers. When the faceplate is re-fitted, a protrusion on the faceplate depresses a mechanical bypass actuator switch, disconnecting the bypass circuit just after the faceplate circuit is connected. The switch is referred to as a “Make Before Break” (MBB) switch.

The design of the mechanical bypass switch is often a limiting factor in extending the operational bandwidth or the tap above 1.2 GHz due to resonances and mismatches caused in the faceplate circuits when the faceplate is mounted on the back box and the switch is in its open position.

It is difficult and time consuming to replace the tap back boxes once installed in a network and replacing back boxes would also cause the signal to all downstream subscribers to be interrupted, hence network operators prefer to only replace the faceplates.

If modifying back boxes in situ, it can be difficult to maintain power passing through the switch to downstream network equipment.

### SUMMARY OF THE INVENTION

In accordance with the invention, there is provided a jumper tool configured for use with a CATV back box comprising a substantially horizontal U-shaped housing bent at each open end of the U-shape to form first and second downwardly depending limbs and further comprising an electrically conductive elongate element located within the housing and passing from the first downwardly depending limb to the second downwardly depending limb so as to provide an electrical connection passing between each limb.

The substantially horizontal U-shaped housing is preferably located in a first plane and the downwardly depending limbs are located in a second plane at an angle to the first plane. The first plane is preferably orthogonal to the second plane.

The electrically conductive elongate element may comprise an elongate electrically conductive wire with a resilient connector at each end.

Preferably each downwardly depending limb is configured to rest on a terminal connection within a CATV back box and may be formed with an internal seat portion to locate against the terminal connection.

The invention will now be described, by way of example, with reference to the accompanying drawings in which:

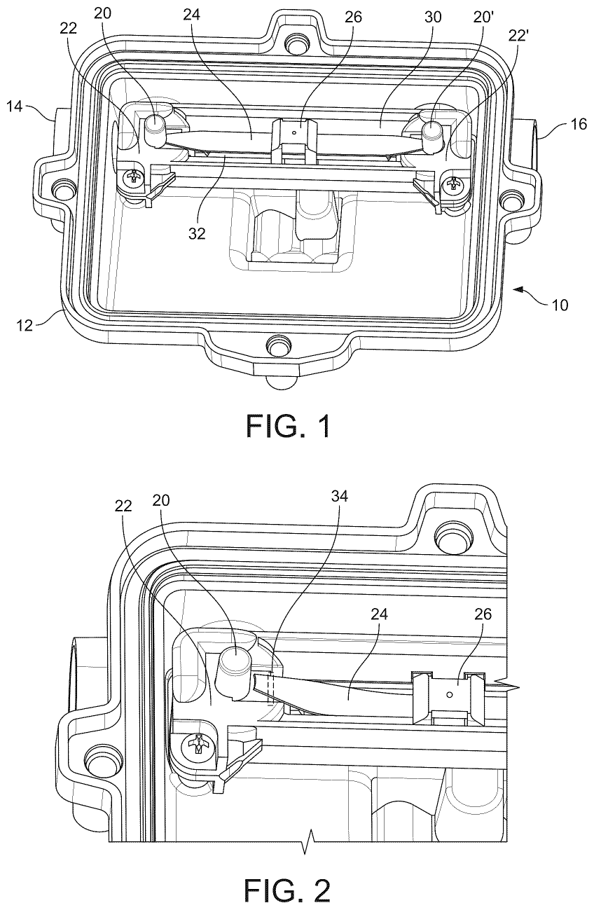

FIG. 1 is a perspective view from above of a Cisco/Scientific Atlanta back box showing a power pass bar;

FIG. 2 is a detailed view of the back box of FIG. 1 when the power pass bar is disconnected;

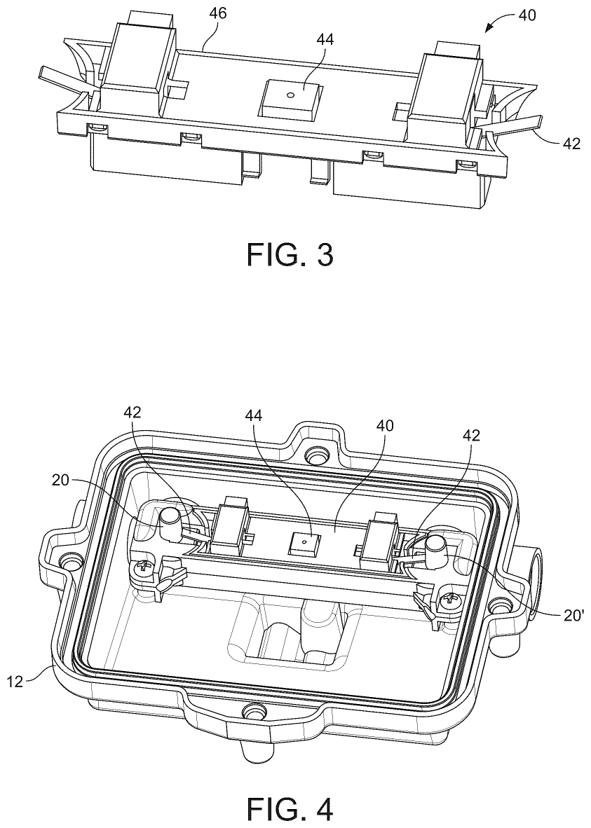

FIG. 3 is a perspective view of the module;

FIG. 4 is a perspective view of the back box of FIG. 1 when the module is in position;

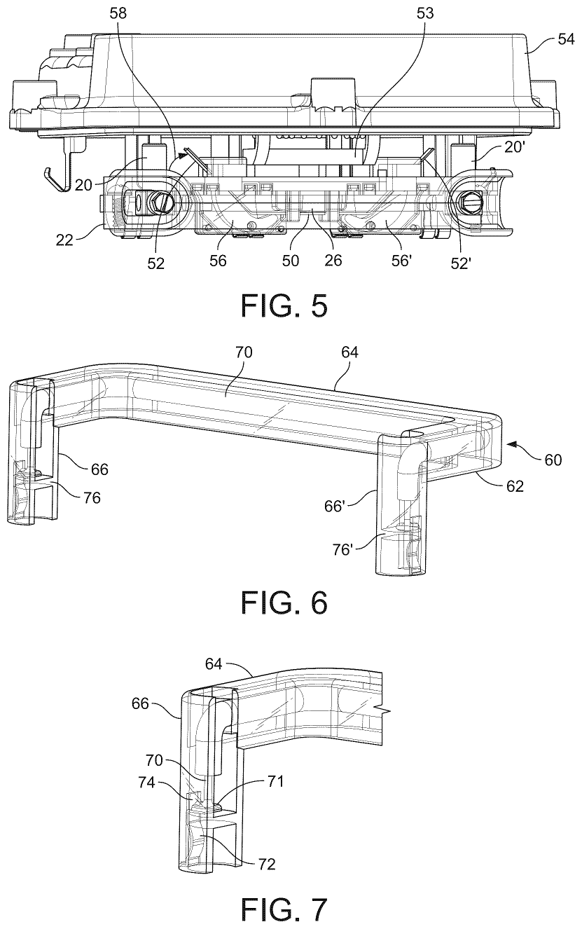

FIG. 5 is a side view in partial X-ray of the module when a faceplate is in position;

FIG. 6 a perspective X-ray view of a jumper tool;

FIG. 7 is an enlarged view of part of FIG. 6;

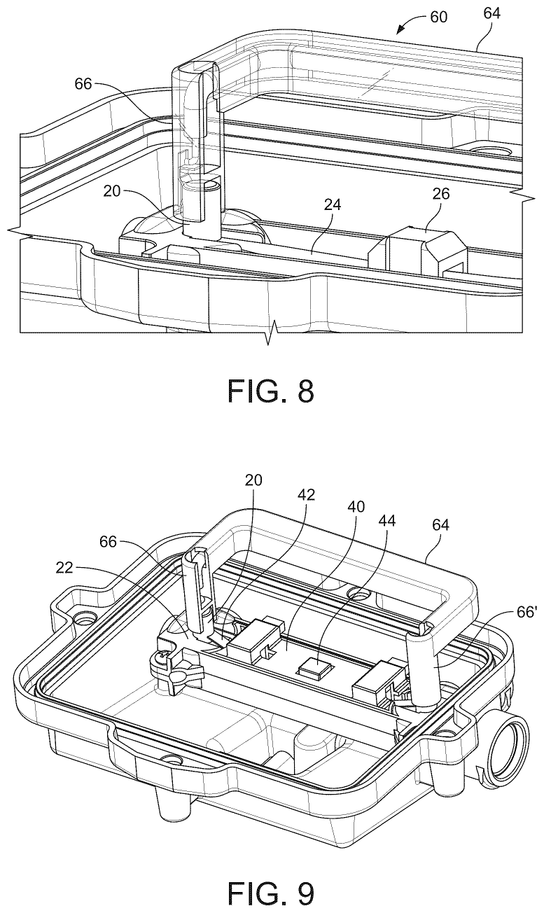

FIG. 8 is an enlarged view of the jumper tool in position in the back box; and

FIG. 9 is a perspective view of a back box with jumper tool and module in position.

### DESCRIPTION

A Cisco/Scientific Atlanta back box 10 is shown in FIG. 1 and comprises back box housing 12 with network input connection 14 and network output connection 16, connector terminals 20, 20′ each surrounded by a respective plastics connector support block 22, 22′, power pass bar 24 extending between connector terminals 20, 20′ and an actuator switch 26 for disconnecting power pass bar 24 from connector terminals 20, 20′ when a faceplate is mounted on back box 10. Channel 30 extends between connector support blocks 22, 22′ and has a central groove 32 to receive power pass bar 24 when it is deflected downwards by actuator switch 26 and disconnected.

In distribution taps, the operational bandwidth above 1.2 GHz is limited due to coupling between the connector blocks and the bypass bar. This is significant on a Cisco/Scientific Atlanta back box because when a faceplate is fitted and actuator switch 26 activated, power pass bar 24 slides downwards into groove 32 as shown in FIG. 2 but remains in physical contact with connector support blocks 22, 22′ in region 34. This results in a high capacitive coupling between connector terminals 20, 20′ and the disconnected power pass bar 24 and limits the operational frequency of a Cisco/Scientific Atlanta back box to below 1.2 GHz.

To resolve this issue and as shown in FIGS. 3 and 4, the existing bar 24 and actuator 26 are replaced with a pre-assembled bypass module 40 incorporating a power pass bar 42 and actuator switch 44 to ensure lower capacitive coupling when a faceplate is fitted and so the ability to operate above 1.2 GHz. Module 40 comprises a substantially rectangular insert 46, typically moulded from plastics material, and configured such that module 40 sits within channel 30 after power pass bar 24 and actuator 26 have been removed.

Power pass bar 42 is generally located within insert 46 but as shown in FIGS. 3 and 4 protrudes from opposing ends of insert 46 so as to be able to contact terminals 20, 20′ when a faceplate is not mounted on back box 10. Power pass bar 42 is configured such that when a faceplate is fitted, power pass bar 42 does not physically contact terminals 20, 20′ nor support blocks 22, 22′ and instead is levered away from support blocks 22, 22′ so as to ensure an air gap between power pass bar 42 and support blocks 22, 22′ and terminals 20, 20′. This produces a lower capacitive coupling and ensures the operational frequency of a Cisco/Scientific Atlanta back box can be extended above 1.2 GHz without physically removing the back box from the CATV network.

Power pass bar 42 can be levered by using one or more fixed pivot points within insert 46 or by using cams as shown in FIG. 5 where power pass bar 42 comprises a central section 50 and angled end sections 52, 52′. When button 26 is pushed downwards by faceplate actuator bar 53 as faceplate 54 is fitted to the back box (not shown), fixed cams 56, 56′ urge against end sections 52, 52′. Due to the resilience of the metal from which power bar 42 is formed, end sections 52, 52′ temporarily alter their angle of deflection and so move away from terminals 20, 20′ as shown by arrow 58 and so move away from connector support 22. Thus by using module 40 fitted between terminals 20, 20′ within a Cisco/Scientific Atlanta back box, an installer can upgrade the operational frequency of network infrastructure with significantly reduced downtime compared to full tap replacement. The replacement bypass module incorporating the MBB switch can be of modular or cassette form.

Whilst the existing power pass bar 24 and actuator switch 26 in back box 10 can simply be removed by prising them out with a medium sized flat bladed screw driver and then replacing with module 40, this interrupts the signal and power passing through the switch to downstream network equipment until the module is fitted, which is not desirable.

To replace the MBB switch of power pass bar 24 and actuator 26 in situ without interrupting the network power to downstream devices, a jumper tool 60 is provided as shown in FIGS. 6 and 7 to electrically connect terminal 20 to terminal 20′ prior to the removal of power pass bar 24 and switch 26 and so ensure signal and power continue to pass through back box 10 as module 40 is positioned within back box 10.

Jumper tool 60 comprises a housing 62 comprising a U-shaped central body 64 with first and second end portions 66, 66′ formed at approximately 90 degrees to central body 64. The central body 64 thus extends laterally to end portions 66, 66′. Within casing 62 is an insulated length of conductive wire 70 which connects at each end via solder 71 to an electrically conductive biased clip 72, 72′ with a cut-away portion 74, 74′ in housing 62 enabling each clip 72, 72′ to contact its associated terminal 20, 20′, see FIG. 7. Each end portion 66, 66′ contains an internal seat portion 76, 76′ to rest on terminal 20, 20′.

When jumper tool 60 is pressed into position over terminals 20, 20′, it electrically and physically connects to connector terminals 20, 20′, see FIG. 8, whilst not disturbing the positioning of bar 24 and the connection of bar 24 connection to terminals 20, 20′. Jumper tool 60 diverts current away from power pass bar 24 and the shape of jumper tool 60 enables easy access to power pass bar 24 and switch 26 for removal and replacement because the lateral displacement of body 64 ensures that an operator can remove power pass bar 24 and switch 26 directly from above without being impeded by central body 64, see FIG. 9.

The existing power pass bar 24 and switch 26 are then removed and replacement MBB switch module 40 inserted, see FIG. 9. Jumper tool 60 is then removed, ready for the faceplate to be reconnected. In this way, use of module 40 ensures the operational frequency of a Cisco/Scientific Atlanta back box can be extended above 1.2 GHz without physically removing the back box from the CATV network. Whilst use of jumper tool 60 is described in relation to a specific back box, it is useable in relation to any design of back box requiring in situ modification of back box components.

1. A jumper tool configured for use with a CATV back box comprising a substantially horizontal U-shaped housing bent at each open end of the U-shape to form first and second downwardly depending limbs and further comprising an electrically conductive elongate element located within the housing and passing from the first downwardly depending limb to the second downwardly depending limb so as to provide an electrical connection passing between each limb.

2. A jumper tool according to claim 1, wherein the substantially horizontal U-shaped housing is located in a first plane and the downwardly depending limbs are located in a second plane at an angle to the first plane.

3. A jumper tool according to claim 2, wherein the first plane is orthogonal to the second plane.

4. A jumper tool according to claim 1, wherein the electrically conductive elongate element comprises an elongate electrically conductive wire with a resilient connector at each end.

5. A jumper tool according to claim 1, wherein each downwardly depending limb is configured to rest on a terminal connection within a CATV back box.

6. A jumper tool according to claim 1, wherein each downwardly depending limb is formed with an internal seat portion to locate against a terminal connection within a CATV back box.
